(19) United States
(12) Patent Application Publication
(10) Pub. No.: US 2014/0312011 A1
(43) Pub. Date: Oct. 23, 2014

(54) MONITORING METHOD FOR PLASMA ARC WELDING AND PLASMA ARC WELDING DEVICE

(71) Applicant: HITACHI CONSTRUCTION MACHINERY CO., LTD., Tokyo (JP)

(72) Inventors: Kazumichi Hosoya, Tsuchiura-shi (JP); Hikaru Yamamoto, Tsuchiura-shi (JP); Toru Nakajima, Tsuchiura-shi (JP); Toyoyuki Sato, Tokyo (JP); Katsunori Wada, Tokyo (JP); Shuhei Kanemaru, Tokyo (JP)

(73) Assignee: HITACHI CONSTRUCTION MACHINERY CO., LTD., Tokyo (JP)

(21) Appl. No.: 14/358,633

(22) PCT Filed: Nov. 16, 2012
(86) PCT No.: PCT/JP2012/079747

§ 371 Date: May 15, 2014

(30) Foreign Application Priority Data
Nov. 17, 2011 (JP) 2011-251739

(51) Int. Cl. B23K 10/02

(52) U.S. Cl. CPC B23K 10/02
USPC 219/121.46; 219/121.45

(57) ABSTRACT

The method of monitoring keyhole welding with a plasma arc includes the step of measuring output voltages when welding is performed with a constant current, and the step of finding peak frequencies and distributions of welding voltages by analyzing frequencies of the welding voltages which correlate to a molten weld pool (P) vibration among the output voltages measured. The method also includes the step of identifying the peak frequencies that correlate to the molten weld pool (P) vibration, and the step of comparing the identified peak frequencies with a frequency range and determining whether the welding is good or bad. Thus, whether or not good keyhole welding is carried out can be determined with excellent precision by simply comparing the peak frequency that correlates to the molten weld pool (P) vibration with the frequency range.

### TECHNICAL FIELD

The present invention relates to a method of monitoring plasma arc welding that enables a high energy density, high speed and high quality welding, and a plasma arc welding device that enables a high energy density, high speed and high quality welding.

### BACKGROUND ART

In general, the plasma arc welding has a higher energy density than other welding such as a gas metal arc (GMA) welding and a gas tungsten arc (GTA) welding. Thus, the plasma arc welding can perform keyhole welding, i.e., can cause the plasma arc to penetrate from a front face (upper face) of a welding base metal (matrix, mother material) to a back face (lower face) while the welding is performed. If the keyhole welding is possible, the welding from the back face of the base metal is unnecessary, and therefore the welding work efficiency is significantly improved. During the keyhole welding, however, the keyhole tends to take an unstable behavior because of various factors, such as the temperature increase of the base metal during the welding, the atmosphere temperature, and magnetic blow caused by grounding. Therefore, how the welding is going on should always be monitored when the welding is performed.

A conventional method of confirming an ongoing situation of welding is disclosed, for example, in Patent Literature 1 (Japanese Patent Application Laid-Open (Kokai) Publication No. 62-89570). In Patent Literature 1, the deviation angle, theta (θ), of the arc flame emitted from a keyhole of the welding workpiece is monitored to monitor the ongoing situation of the welding. Patent Literature 2 (Japanese Patent Application Laid-Open Publication No. 62-93072) teaches a back shield jig tool that is attached to the back face of the welding workpiece to shield the welding target area of the welding workpiece, and detects the voltage between the back shield jig tool and the base metal. Then, the detected voltage is compared with a reference voltage to check the discrepancy of the detected voltage from the reference voltage and confirm the welding situation.

### PATENT LITERATURES

PATENT LITERATURE 1: Japanese Patent Application Laid-Open (Kokai) Publication No. 62-89570

PATENT LITERATURE 2: Japanese Patent Application Laid-Open (Kokai) Publication No. 62-93072

### SUMMARY OF THE INVENTION

### Problems to be Solved by the Invention

The method, such as that disclosed in Patent Literature 1, however, has to attach the back shield jig tool on the back face of the welding workpiece along the welding line and provide the back shield jig tool with a plurality of light-receiving elements. This entails additional cost, time and labor. Because the arc flame changes with various factors, such as magnetic blow, it is difficult to accurately know (determine) the welding situation if the deviation angle theta of the arc flame is only monitored. The method, such as that discloses in Patent Literature 2, compares the voltage generated between the back shield jig tool and the base metal with the reference voltage, and determines the welding situation based on the discrepancy between the generated voltage and the reference voltage only. Thus, it is difficult to accurately detect presence/absence of abnormalities during the welding. In addition, neither Patent Literature 1 nor Patent Literature 2 can determine the quality (good or bad) of the penetration bead formed on the back face of the base metal, which in particular influences (decides) the decentness of the welding.

The present invention is proposed to address these problems, and an object of the present invention is to provide a novel method of monitoring plasma arc welding that can precisely determine whether or not a stable penetration bead having a constant height will be created without dripping (dropping) and irregularities when the keyhole welding is performed, and a novel plasma arc welding device that can precisely determine whether or not a stable penetration bead having a desired height will be created without dropping and irregularities when the keyhole welding is performed.

### Solution to Overcome the Problems

In order to overcome these problems, the inventors carried out intensive studies and experiments, and found that there was relationship between shaking behavior or oscillation (frequency) of the weld pool formed on (in) the back face of the base metal during the welding and the behavior (frequency) of the welding voltage output (applied) during the welding. The inventors arrived at the present invention based on such finding.

Specifically, when the above-described keyhole welding is carried out by the plasma arc, as shown in FIG. 2, a weld pool P is formed on the back face of the base metal 15 by the melted base metal 15, which is melted by the heat of the plasma arc 16 generated from a welding torch 10. The weld pool extends in the longitudinal direction of the base metal 15, and is formed behind the keyhole (plasma arc) in the welding direction. The inventors found that the shaking movement (vibration) of the weld pool P in the forward and backward directions with respect to the welding direction created a stable and constant-height penetration bead (gentle shape with a desired height). If the shaking movement (oscillation) of the weld pool P is too large, the molten metal drops. Thus, the inventors found that the shaking movement (oscillation) of the weld pool P had a characteristic or natural frequency (e.g., 30-40 Hz) in order to create a stable penetration bead having a desired height. The natural frequency of the weld pool changes with the material of the base metal 15, the size (mass) of the weld pool P, the viscosity of the weld pool, and other factors. With such finding, the inventors carried out further intensive studies on the shaking movement (oscillation) of the weld pool P. Then, the inventors found that the shaking movement (oscillation) of the weld pool P related to the peak frequency distribution, obtained upon frequency analysis of the welding voltage applied during the keyhole welding. The inventors also found that this relationship was different from when a constant current was used as the welding current to when a pulse current was used as the welding current.

To achieve the above-mentioned object, the first aspect of the present invention provides a method of monitoring welding that continuously welds a welding target area of a welding workpiece when forming a keyhole in the welding target area of the welding workpiece by a plasma arc. The method includes the step of measuring output (applied) voltages when a constant current is used for the welding. This step is an output voltage measuring step. The method also includes the step of analyzing the frequencies of those welding voltages, among the output voltages measured by the output voltage measuring step, which possibly correlate to the vibration of the weld pool formed on the back face of the base metal during the welding, to obtain the peak frequencies of the welding voltages (output voltages) and their distributions. This step is a welding voltage frequency analyzing step. The method also includes the step of identifying those peak frequencies which possibly correlate to the vibration of the weld pool, based on the frequency analysis results of the welding voltage frequency analyzing step. This step is a peak frequency identifying step. The method also includes the step of comparing the peak frequencies identified by the peak frequency identifying step with a preset frequency range to determine the quality (good or bad) of the welding. This step is a determination step.

With such method, it is possible to determine the quality of the keyhole welding by simply comparing the peak frequencies which correlate to the vibration of the weld pool formed on the back face of the base metal during the welding, with the preset frequency range. In other words, if the peak frequencies which correlate to the vibration of the weld pool are compared with the preset frequency range, it is possible to precisely determine whether a stable penetration bead having a constant height (desired height) can be obtained without dropping and irregularities, when the keyhole welding is performed with a constant current.

The second aspect of the present invention provides another monitoring method for the plasma arc welding defined by the first aspect of the invention, wherein the determination step determines that the quality of the welding is good if those peak frequencies which correlate to the vibration of the weld pool, identified by the peak frequency identifying step, fall in the preset frequency range, and determines that the quality of the welding is bad if the peak frequencies identified by the peak frequency identifying step do not fall in the preset frequency range.

By simply checking the specific relationship between the identified peak frequencies which correlate to the vibration of the weld pool and the preset frequency range, it is possible to precisely determine whether or not a stable penetration bead having a desired height is obtained without dropping and irregularities when the keyhole welding is performed with a constant current.

The third aspect of the present invention provides another monitoring method for the plasma arc welding defined by the second aspect of the invention, wherein the determination step determines that the quality of the welding is bad if there is any peak value equal to or greater than a predetermined level, in addition to the peak value in the frequency range.

By checking the presence/absence of an additional peak that is equal to or higher than the predetermine level, outside the frequency range, it is possible to further precisely determine whether a stable penetration bead having a desired height can be obtained without irregularities.

The fourth aspect of the present invention provides another method of monitoring welding that continuously welds a welding target area of a welding workpiece when forming a keyhole in the welding target area of the welding workpiece by a plasma arc. The method includes the step of measuring output (applied) voltages when a pulse current is used for the welding. This step is an output voltage measuring step. The method also includes the step of analyzing the frequencies of those welding voltages, among the output voltages measured by the output voltage measuring step, which possibly correlate to the vibration of the weld pool formed on the back face of the base metal during the welding, to obtain the peak frequencies of the welding voltages (output voltages) and their distributions. This step is a welding voltage frequency analyzing step. The method also includes the step of identifying those peak frequencies which possibly correlate to the vibration of the weld pool, based on the frequency analysis results of the welding voltage frequency analyzing step. This step is a peak frequency identifying step. The method also includes the step of comparing the peak frequencies identified by the peak frequency identifying step with a pulse frequency of the pulse current to determine the quality (good or bad) of the welding. This step is a determination step.

With such method, it is possible to determine the quality of the keyhole welding with the pulse current by simply comparing the peak frequencies which correlate to the vibration of the weld pool with the pulse frequency of the pulse current. In other words, if the peak frequencies which correlate to the vibration of the weld pool are compared with the pulse frequency of the pulse current, it is possible to precisely determine whether a stable penetration bead having a constant height (desired height) can be obtained without dropping and irregularities, when the keyhole welding is performed with the pulse current.

The fifth aspect of the present invention provides another monitoring method for the plasma arc welding defined by any one of the first to fourth aspects of the invention, wherein when the determination step determines that the welding quality is good under the above-mentioned criteria, the determination step further checks the welding quality based on variations in the welding voltage per unit time and the discrepancy from the reference voltage.

If the welding is determined to be good under the above-described criteria, then it is further determined whether the welding quality is good or bad based on variations in the welding voltage per unit time and the discrepancy of the welding voltage from the reference voltage. This makes it possible to further precisely determine whether the penetration bead having a gentle shape and a desired height can be obtained without dropping and irregularities when the keyhole welding is performed.

The sixth aspect of the present invention provides a plasma arc welding device for continuously welding a welding target area of a welding workpiece while forming a keyhole in the welding target area of the welding workpiece by use of a welding torch. The welding torch is configured to generate a plasma arc. The plasma arc welding device includes an output voltage measuring unit configured to measure an output voltage when a constant current is used for the welding. The welding device also includes a welding voltage frequency analyzing unit configured to analyze the frequencies of those welding voltages, among the output voltages measured by the output voltage measuring unit, which possibly correlate to the vibration of the weld pool formed on the back face of the base metal during the welding, to obtain the peak frequencies of the welding voltages (output voltages) and their distributions. The welding device also includes a peak frequency identifying unit configured to identify those peak frequencies which possibly correlate to the vibration of the weld pool, based on the frequency analysis results of the welding voltage frequency analyzing unit. The welding device also includes a determination unit configured to compare the peak frequencies identified by the peak frequency identifying unit with a preset frequency range to determine the quality (good or bad) of the welding.

With the welding device having such configuration, it is possible to determine the quality of the keyhole welding performed with the constant current, by simply comparing the peak frequencies which correlate to the vibration of the weld pool with the preset frequency range, like the first aspect of the present invention. In other words, if the peak frequencies which correlate to the vibration of the weld pool are compared with the preset frequency range, it is possible to precisely determine whether a stable penetration bead having a constant height can be obtained without dropping and irregularities, when the keyhole welding is performed with the constant current.

The seventh aspect of the present invention provides another plasma arc welding device for continuously welding a welding target area of a welding workpiece while forming a keyhole in the welding target area of the welding workpiece by use of a welding torch. The welding torch is adapted to generate a plasma arc. The welding device includes an output voltage measuring unit configured to measure an output voltage when a pulse current is used for the welding. The welding device also includes a welding voltage frequency analyzing unit configured to analyze the frequencies of those welding voltages, among the output voltages measured by the output voltage measuring unit, which possibly correlate to the vibration of the weld pool formed on the back face of the base metal during the welding, to obtain the peak frequencies of the welding voltages (output voltages) and their distributions. The welding device also includes a peak frequency identifying unit configured to identify those peak frequencies which possibly correlate to the vibration of the weld pool, based on the frequency analysis results of the welding voltage frequency analyzing unit. The welding device also includes a determination unit configured to compare the peak frequencies identified by the peak frequency identifying unit with a pulse frequency of the pulse current to determine the quality (good or bad) of the welding.

With the welding device having such configuration, it is possible to determine the quality of the keyhole welding with the pulse current by simply comparing the peak frequencies which correlate to the vibration of the weld pool with the pulse frequency of the pulse current, as in the fourth aspect of the present invention. In other words, if the peak frequencies which correlate to the vibration of the weld pool are compared with the pulse frequency of the pulse current, it is possible to precisely determine whether a stable penetration bead having a constant height can be obtained without dropping and irregularities, when the keyhole welding is performed with the pulse current.

### Advantages of the Invention

According to the present invention, it is possible to precisely determine whether a stable penetration bead having a constant (desired) height can be obtained by the keyhole welding without dropping and irregularities, by simply comparing the peak frequencies which correlate to the vibration of the weld pool formed on the back face of the base metal during the welding with the preset frequency range.

### BRIEF DESCRIPTION OF THE DRAWINGS

FIG. 1 is a block diagram of a plasma arc welding device 100 according to one embodiment of the present invention.

FIG. 2 is a conceptual view showing a behavior of a weld pool P formed on a back face of a base metal 15 during the welding.

FIG. 3 is a conceptual view of welding, with a welding torch 10 being inclined relative to the welding workpiece 14 at a predetermined angle θ (theta).

FIG. 4 shows a waveform of a pulse current used in the method of the present invention.

FIG. 5 is an enlarged partial view of a welding workpiece 14 to depict an example of welding conditions related to the welding workpiece.

FIG. 6 is a flowchart of the processing executed in the monitoring method for plasma arc welding according to the present invention.

FIG. 7 is a flowchart of the processing for determining the quality (good or bad) of the welding when a constant current is used.

FIG. 8 is a graph showing an exemplary inclination of the welding voltage change, and an exemplary discrepancy of the welding voltage from a reference voltage.

FIGS. 9A-9C show frequency distributions, which are obtained by analyzing the frequency of the welding voltage when a constant current is used.

FIG. 10 is a cross-sectional view of the welding target area, taken in the welding direction, after the keyhole welding is finished according to the present invention.

FIG. 11 is a flowchart of another processing for determining the quality of the welding when a constant current is used.

FIG. 12 is a flowchart of the processing for determining the quality of the welding when a pulse current is used.

FIGS. 13A and 13B show frequency distributions, which are obtained by analyzing the frequency of the welding voltage when the pulse current is used.

FIG. 14 is a flowchart of another processing for determining the quality of the welding when a pulse current is used.

### BEST MODE FOR CARRYING OUT THE INVENTION

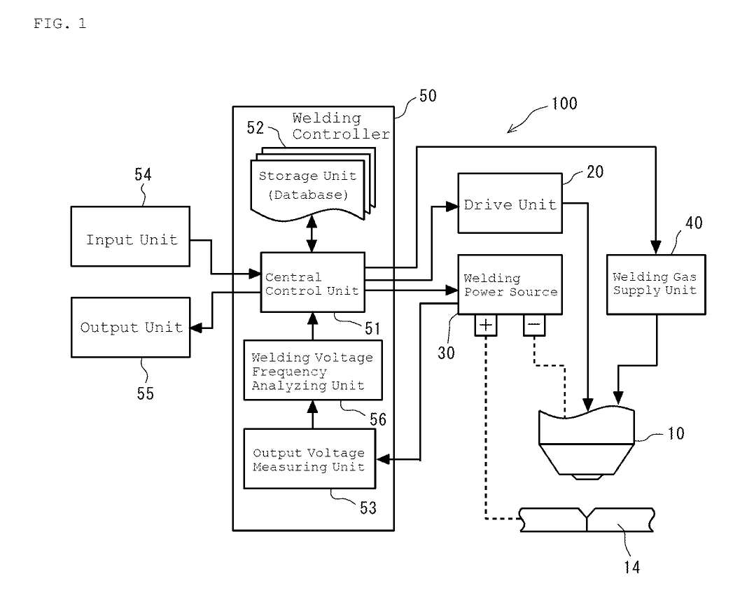

A method of monitoring plasma arc welding and a plasma arc welding device according to embodiments of the present invention are now described with reference to the accompanying drawings. FIG. 1 is a block diagram showing a configuration of a plasma arc welding device 100 according to the present invention. As illustrated, the plasma arc welding device 100 includes, as its major components, a welding torch 10, a drive unit 20 for driving the welding torch 10, a power source 30 for feeding electricity to the welding torch and the welding workpiece for welding, a gas supply unit 40 for supplying the welding torch 10 with a welding gas, and a welding controller 50 for controlling the welding torch 10, drive unit 20, power source 30 and gas supply unit 40.

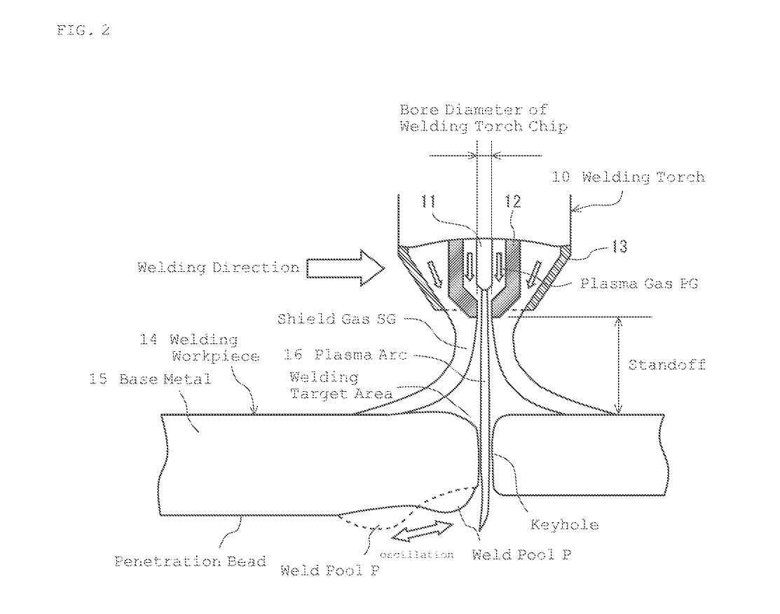

As shown in FIG. 2, the welding torch 10 has a tungsten electrode 11 which is covered with a welding torch chip 12. The welding torch 10 also has a shield cap 13 for shielding the welding torch chip 12. A high frequency generator (not shown) is used to generate a pilot arc between the tungsten electrode 11 and the welding torch chip 12. Then, a working gas such as argon (Ar) gas flows in the welding torch chip 12. The working gas is “plasma gas PG” in the drawing. The plasma gas PG is ionized by the heat of the arc to become a good conductor of the arc current, and a plasma arc 16 is generated at a super high temperature (10000-20000 degrees C.) between the tungsten electrode 11 and the matrix (welding based metal) 15. The plasma arc 16 is allowed to penetrate the base metal 15 from the front face (upper face) of the base metal 15 to the back face (lower face) to enable the keyhole welding. Between the welding torch chip 12 and the shield cap 13, supplied is a shield gas SG that includes argon (Ar) and hydrogen (H₂), argon (Ar) and oxygen (O₂), argon (Ar) and carbon dioxide gas (CO₂), or the like. The shield gas SG protects the welding target area from the atmosphere to maintain the decentness of the welding.

As shown in FIG. 3, for example, the drive unit 20 supports and fixes the welding torch 10 at a predetermined distance from the welding workpiece 14 and at a predetermined angle theta relative to the welding workpiece 14. The drive unit 20 causes the welding torch 10 to move (travel) along the welding line of the welding workpiece 14 at a desired speed in response to a control signal received from the welding controller 50. It should be noted that the drive unit 20 may fixedly support the welding workpiece 14 and may cause the welding torch 10 to move relative to the welding workpiece 14. It should be also noted that the drive unit 20 may fixedly support the welding torch 10 and may cause the welding workpiece 14 to move, or cause both the welding torch 10 and the welding workpiece 14 to move (travel) simultaneously.

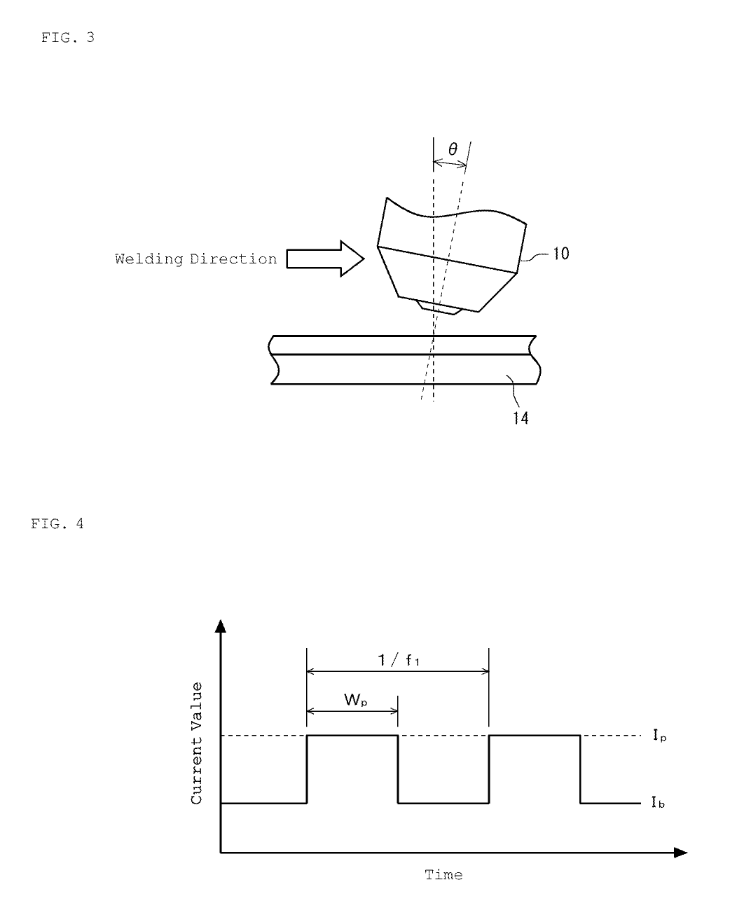

The welding power source 30 feeds a predetermined voltage to provide a necessary current to generate the plasma arc 16 between the welding torch 10 and the base metal 15. The current value and the voltage value are precisely controlled by the welding controller 50. The welding power source 30 may supply a pulse current having, for example, a rectangular waveform, at a predetermined frequency as shown in FIG. 4, or may supply a constant current. FIG. 4 depicts one example of the waveform of the pulse current supplied from the welding power source 30. Iₚ designates a peak current, I_{b} designates a base current, wₚ designates a pulse width, and f₁ designates a pulse frequency. The gas supply unit 40 supplies the welding torch 10 with the welding gas, such as the plasma gas and the shield gas. The gas flow rate, gas supply timing and the like of the gas supply unit are appropriately controlled by the welding controller 50.

The welding controller 50 includes a central control unit 51, a storage unit (database) 52, an output voltage measuring unit 53, a welding voltage frequency analyzing unit 56, an input unit 54 and an output unit 55. The central control unit 51 has information processing devices (e.g., CPU, ROM, RAM, and input/output interface) for the computer system and other components. The central control unit 51 controls the above-mentioned components 10-40 and other components based on the operation instructions entered from the input unit 54 and/or appropriate control programs.

The storage unit (database) 52 is a storage device including HDD and semiconductor memories, which enables the data writing and reading. The storage unit 52 stores not only various control programs but also, at least, various welding conditions as well as data about the different natural frequencies of the weld pool to be formed on the back side of the keyhole for the respective welding conditions. The programs and data in the storage unit are writable and readable.

As such, the storage unit (database) 52 stores, at least, a plurality of welding conditions and the information about the natural frequencies of the weld pool P, which correspond to the respective welding conditions, in the form of database. Each (each set) of the welding conditions uniquely decides the natural frequency of the weld pool P. The welding conditions may include conditions related to the welding workpiece 14 and conditions related to the welding work. The conditions related to the welding workpiece 14 may include the material (type of the base metal), the plate thickness t (see FIG. 5), the groove angle θ (theta), and the root length r. The conditions related to the welding work may include the welding current, the welding speed, the pilot gas flow rate, the pilot gas composition, the shield gas composition, the standoff (gap between the base metal 15 and the welding torch chip 12; FIG. 2), the bore diameter of the welding torch chip, and the angle theta of the welding torch 10 to the welding workpiece 14 (see FIG. 3).

The output voltage measuring unit 53 measures, always or at desired timing, the output voltage of the welding power source 30 and sends the measured output voltage to the welding voltage frequency analyzing unit 56 and the central control unit 51. The welding voltage frequency analyzing unit 56 analyzes the frequency of that welding voltage which correlates to the frequency of the weld pool P, among the output voltages measured by the output voltage measuring unit 53, so as to obtain the peak frequency and the distribution thereof. The welding voltage frequency analyzing unit 56 sends the analysis results to the central control unit 51. The input unit 54 may have various types of input devices such as a keyboard and a mouse. The welding conditions and operation commands/instructions are entered from the input unit 54. The output unit 55 may have various types of output devices such as a monitor device (e.g., CRT and LCD) and a speaker. The output unit 55 displays the welding conditions entered from the input unit 54 to confirm the accurate entering of the welding conditions. The output unit 55 also displays information such as various situations of the ongoing welding. It should be noted that the output unit 55 may have a touch panel or the like in its monitor screen, which provides the output unit with an additional function, i.e., input function. Then, the output unit 55 may also be able to function as the input unit 54.

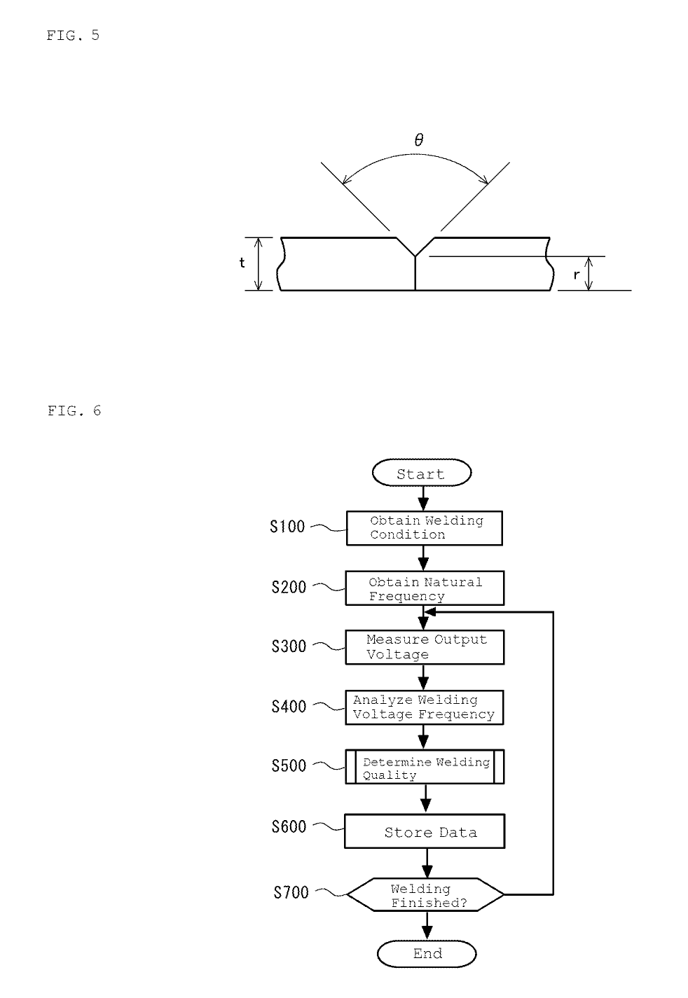

One exemplary method of monitoring the plasma welding performed by the plasma arc device 100 having the above-described structure will be described with reference to FIG. 6 to FIG. 10 and other drawings. Upon receiving the conditions related to the welding workpiece 14 and the welding start command from the input unit 54, the welding controller 50 (central control unit 51) of the welding device 100 of the invention selects and retrieves an optimal welding work condition, which most fits the conditions related to the welding workpiece 14, from the storage unit (database) 52. Then, the controller controls the components 10-40 in accordance with the welding work conditions to start the welding. The welding is carried out with the constant current.

As the keyhole welding starts, the welding controller 50 (central control unit 51) firstly obtains the welding condition which is entered from the input part 54 (Step S100), and then accesses the storage unit 52 to obtain the natural frequency of the weld pool P which is uniquely decided under the obtained welding condition (Step S200), as shown in FIG. 6. Upon obtaining the natural frequency of the weld pool P, the welding controller 50 (central control unit 51) measures the output voltages, and analyzes the frequencies of those welding voltages which correlate to the frequency of the weld pool P, among the measured output voltages, to obtain the peak frequencies and distributions (Step S300 and S400). Upon obtaining the welding voltages, the peak frequencies and their distributions, then the welding controller (central control unit 51) proceeds to Step S500 to determine the quality (good or bad) of the welding.

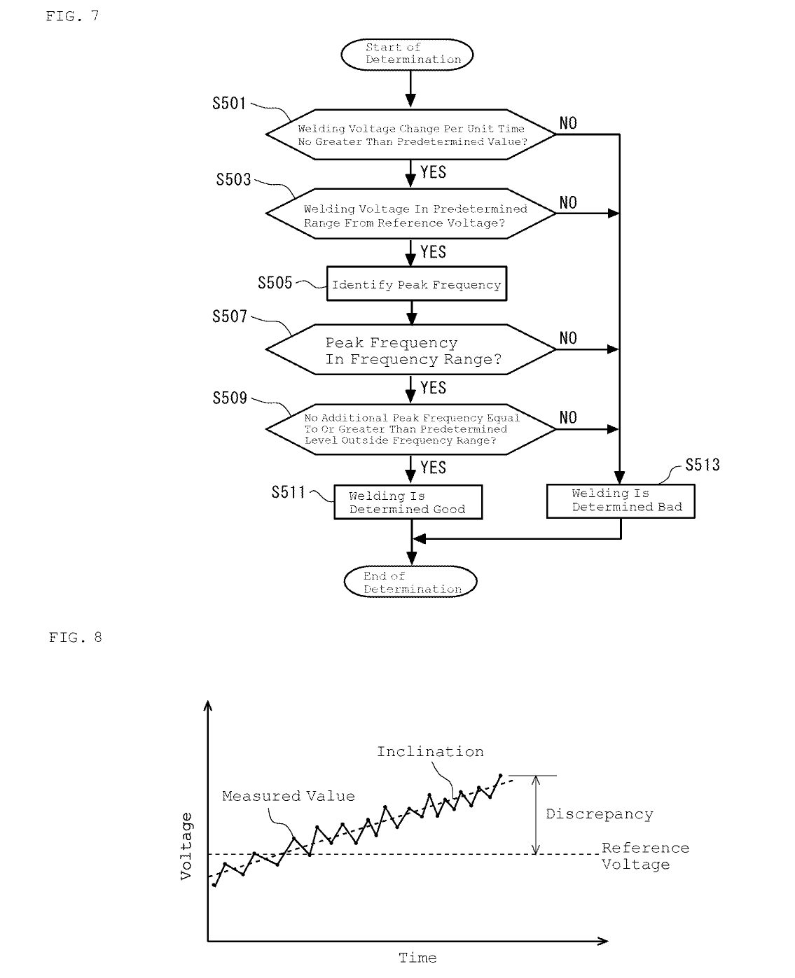

FIG. 7 illustrates the processing of the welding quality determination to be executed in Step S500. At the first step in this welding quality determination processing, i.e., at Step S501, it is determined whether an amount of the variations in the output welding voltage (applied welding voltage) per unit time is no greater than a predetermined value. The amount of the variations in the welding voltage is determined by the inclination of the line in the graph that shows the welding voltage change as shown in FIG. 8, for example. Specifically, if there is a steep change in the welding voltage in a short time, a serious deficiency (e.g., the keyhole may become too large or no keyhole may not be formed) may result at a high possibility. If it is determined at Step S501 that the amount of the variations in the welding voltage per unit time is not equal to or not less than the predetermined value (NO at Step S501), then the controller proceeds to Step S513. On the other hand, if it is determined at Step S501 that the amount of the variations in the welding voltage per unit time is no greater than the predetermined value (YES at Step S501), then the controller proceeds to the next Step, i.e., Step S503.

At Step S503, it is determined how far the welding voltage is from the reference voltage, i.e., the discrepancy of the welding voltage from the reference voltage is detected. It is determined whether the discrepancy is in a predetermine range, measured from the reference voltage. Specifically, as shown in FIG. 8, if the welding voltage is greatly distant from the reference voltage, a serious deficiency (e.g., the keyhole may become too large or no keyhole may not be formed) may also result at a high possibility. If it is determined at Step S503 that the discrepancy from the reference voltage is not in the predetermine range (NO at Step S503), then the controller proceeds to Step S513. On the other hand, if it is determined at Step S503 that the discrepancy from the reference voltage is in the predetermine range (YES at Step S503), then the controller proceeds to the subsequent Step, i.e., Step S505.

At Step S505, a peak frequency is identified (specified) which correlates to the vibration of the weld pool P, based on the frequency analysis result of the preceding step, i.e., Step S400. Then, the controller proceeds to Step S507. At Step S507, it is determined whether the identified peak frequency is in the predetermined frequency range. Because this peak frequency corresponds to the actual frequency of the weld pool P, this step determines whether this actual number of vibrations (frequency) substantially matches the natural frequency of the weld pool P, which is already read.

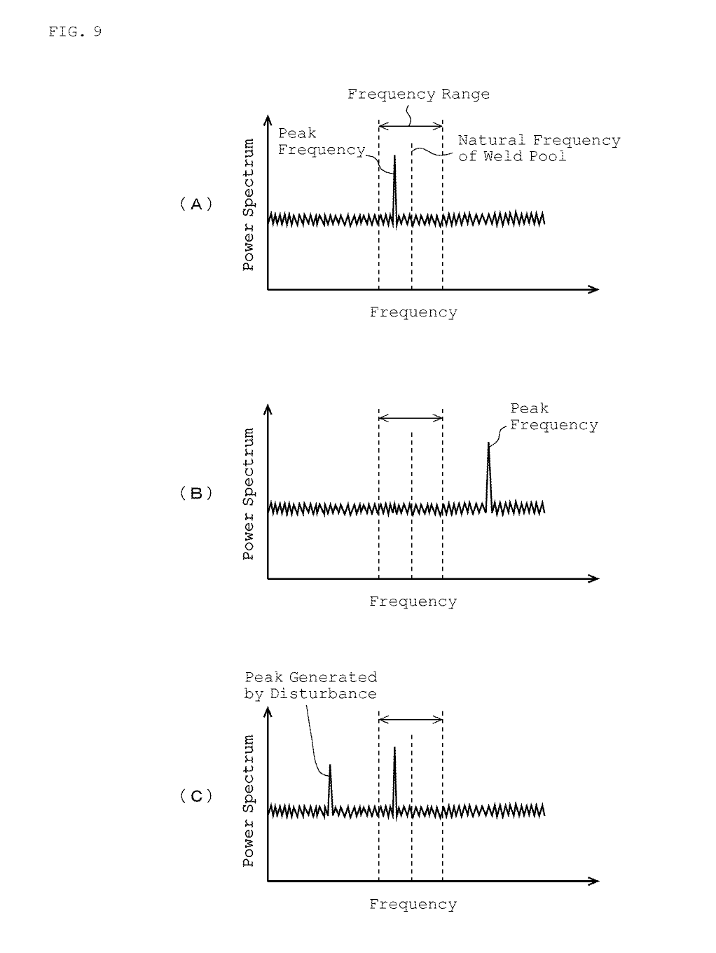

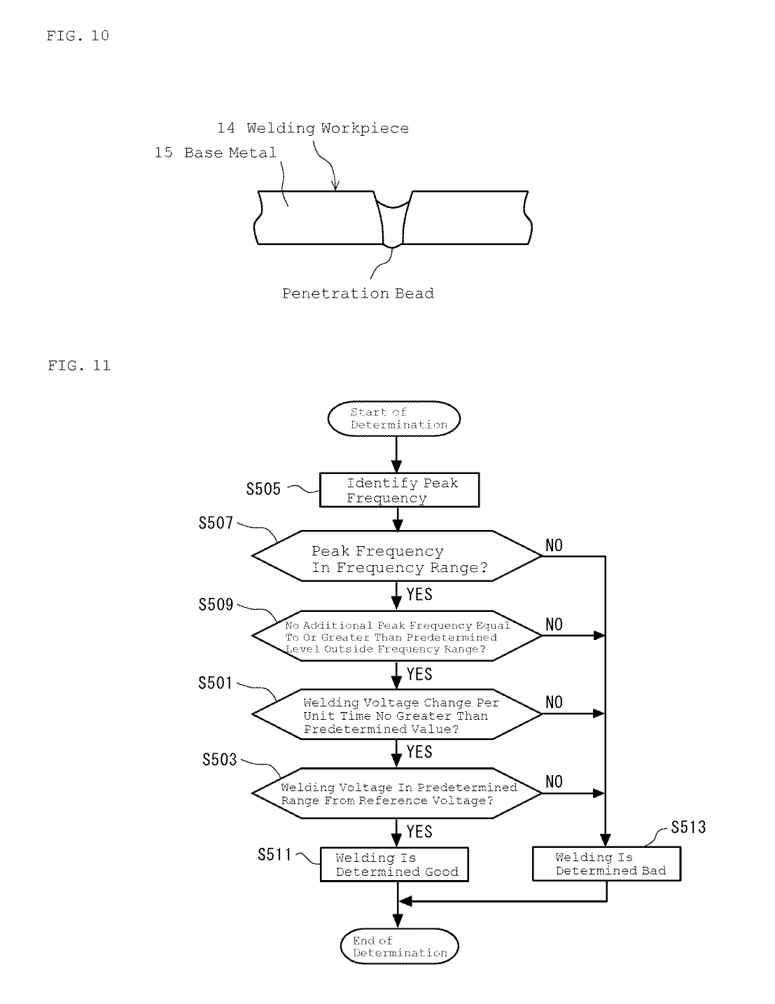

As shown in FIG. 9A, for example, if it is determined that the identified peak frequency falls in the predetermined frequency range (YES), it is then determined that the actual frequency of the weld pool P is substantially equal to the natural frequency of the weld pool, and the controller proceeds to Step S509. As shown in FIG. 9B, for example, on the other hand, if it is determined that the identified peak frequency does not fall in the predetermined frequency range (NO), it is then determined that the actual frequency of the weld pool P is considerably far from the natural frequency of the weld pool, and the controller proceeds to Step S513. When the frequency of the actual weld pool P is substantially equal to the natural frequency of the weld pool, it is considered that the good welding is performed. On the other hand, when the frequency of the actual weld pool P is considerably far from the natural frequency of the weld pool, it is considered that the good welding is not performed.

At Step S509, it is determined whether there is any peak, other than the identified peak frequency, that is equal to or greater than the predetermined level due to noises or disturbance, although it is already determined that the identified peak frequency is in the predetermined frequency range. If there is a large peak that is equal to or greater than the predetermined level, other than the identified peak frequency, then an accurate determination becomes difficult under the influences of that large peak. For example, as shown in FIG. 9C, if it is determined that there is a large peak outside the predetermined frequency range (NO), the controller proceeds to Step S513. If it is determined that there is no large peak outside the predetermined frequency range (YES), then the controller proceeds to Step S511.

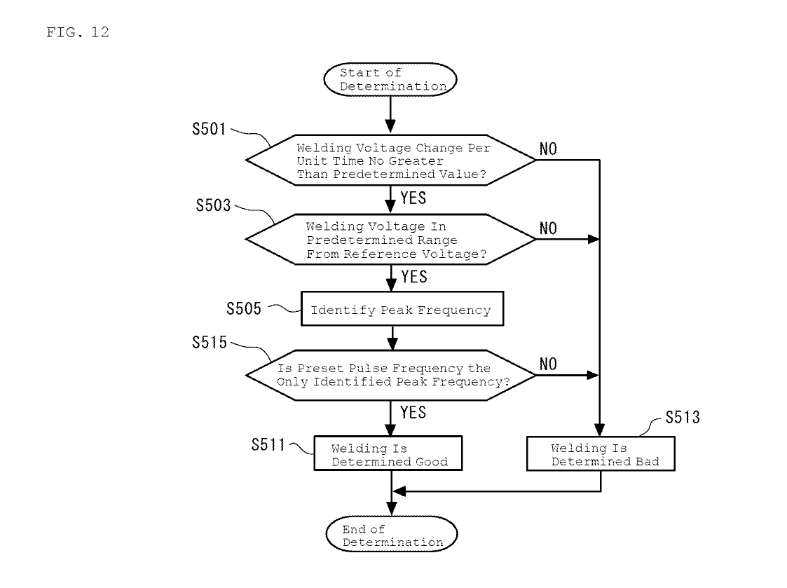

At Step S511, it is determined that the good welding is performed such that the penetration bead does not have irregularities as shown in FIG. 10, because the all of the four criteria at Steps S501-S509 are met. Then, the processing is terminated. At Step S513, on the other hand, one of the four criteria recited in Steps S501-S509 is not met, and therefore it is determined that the welding is not good and the processing is finished. As the processing for determining the welding quality is finished in the above-described manner, the controller proceeds to Step S600 in FIG. 3 to store the data in the storage unit 52, and proceeds to Step S700. At Step S700, it is determined whether the welding is finished or not. The above-described processing is repeated at predetermined intervals or for predetermined welding lengths until the welding is finished.

As described above, the monitoring method of the present invention can precisely determine in real time whether it is possible to obtain a penetration bead having a stable and gentle height without dropping and irregularities when the keyhole welding is performed with a plasma arc. Consequently, it is possible to accurately make a determination on whether to continue the welding or stop the welding. Even if the welding deficiency occurs, a repair work to the welding deficiency or other after-treatments can be minimized or greatly reduced.

In the processing for determining the welding quality of this embodiment (Step S500), as shown in FIG. 7, the amount of welding voltage change and the discrepancy are firstly determined, the peak frequency is subsequently identified, and then the welding quality determination is made based on the identified position of the peak frequency or other factors. It should be noted that the order of these determinations is not limited to the above-mentioned order. For example, as illustrated in FIG. 11, the welding quality determination may firstly be made based on the detected position of the peak frequency (Steps S505, S507 and S509), and then the amount of welding voltage change and the discrepancy may be determined (Steps S501 and S503).

Referring now to FIG. 12, the processing for determining the welding quality of Step S500 will be described when a pulse current is used as the welding current. In this embodiment, as shown in FIG. 12, the peak frequency identification is finished at Step S505 and then it is determined at Step S515 whether there is any peak frequency identified other than the preset pulse frequency of the pulse current.

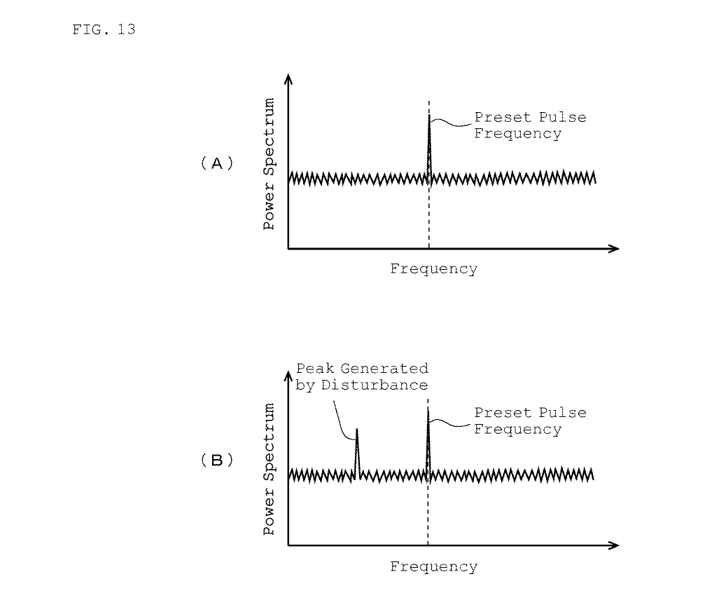

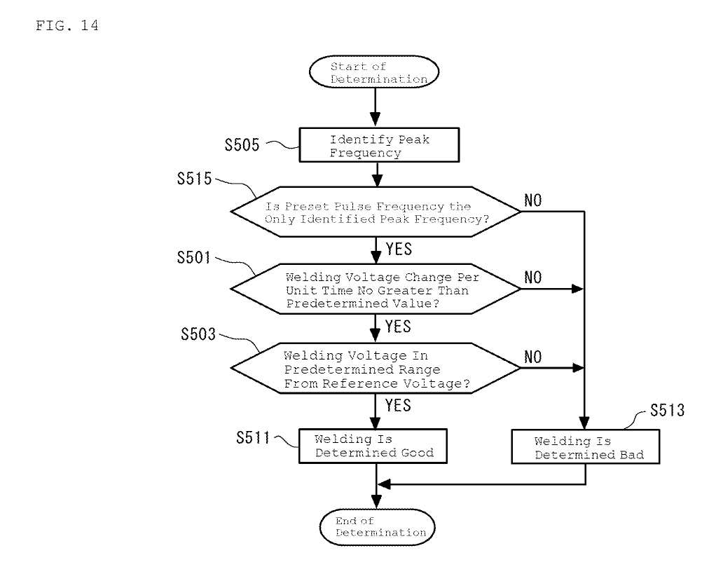

If the determination of this step indicates that the only identified peak frequency is the preset pulse frequency, as shown in FIG. 13A, the controller proceeds to Step S511. On the other hand, if there is another identified peak that is generated by noises or disturbance and that is equal to or greater than the predetermined level, other than the peak frequency that is equal to the preset pulse frequency, as shown in FIG. 13B, then the controller proceeds to Step S513. Similar to the preceding embodiment, Step S511 determines that the welding quality is good, and the processing is finished, and Step S513 determines that the welding quality is bad and the welding is finished.

If the pulse current is used as the welding current as described above, it is possible to more precisely determine the quality of the keyhole welding by determining the relationship between the peak frequency of the welding current and the pulse frequency of the pulse current. It should be noted that the order of the determination steps is not limited to the above-described order of this embodiment. For example, as shown in FIG. 14, the determination of Step S515 may be performed prior to the determination steps for the welding voltage variations and the discrepancy (Steps S501 and S503). If the pulse current is used as the welding current, the step of obtaining the natural frequency (Step S200 in FIG. 6) may be omitted.

Among the units or steps that constitute the present invention described in the “SOLUTION TO OVERCOME THE PROBLEMS” section, the output voltage detection unit (or step) for detecting the output (applied) voltage when the welding is performed with a constant current or a pulse current corresponds, for example, to the output voltage measuring unit 53 shown in FIG. 1 or the like, or to the output voltage measuring step S300 shown in FIG. 6 or the like. The welding voltage frequency analyzing unit (or step) for analyzing the frequencies of those welding voltages which correlate to the vibration of the weld pool P formed on the back face of the base metal during the welding, among the detected output voltages, to obtain their peak frequencies and distributions corresponds, for example, to the welding voltage frequency analyzing unit 56 shown in FIG. 1 and Step S400 for analyzing the welding voltage frequency in FIG. 6. The peak frequency identifying unit (or step) for identifying the peak frequency that correlates to the welding pool vibration based on the frequency analysis result corresponds, for example, to the central control unit 51 shown in FIG. 1 or the like, and to Step S505 shown in FIG. 7 or the like. The determination unit (or step) for determining the welding quality by comparing the identified peak frequency with the preset frequency range corresponds, for example, to the central control unit 51 shown in FIG. 1 or the like, and to Step S500 shown in FIG. 6 and the welding quality determination process shown in FIGS. 7 and 11 or the like. The determination unit for determining the welding quality by comparing the peak frequency of the welding voltage with the pulse frequency of the pulse current corresponds, for example, to the central control unit 51 shown in FIG. 1 or the like, and to Step S500 shown in FIG. 6 and the welding quality determination process shown in FIGS. 12 and 14 or the like.

### REFERENCE NUMERALS AND SYMBOLS

100 Plasma Arc Welding Device
10 Welding Torch
11 Tungsten Electrode
12 Welding Torch Chip
13 Shield Cap
14 Welding Workpiece
15 Base Metal
16 Plasma Arc
20 Drive Unit
30 Welding Power Source
40 Welding Gas Supply Unit
50 Welding Controller
51 Central Control Unit
52 Storage Unit (Database)
53 Output Voltage Measuring Unit
54 Input Unit
55 Output Unit
56 Welding Voltage Frequency Analyzing Unit
P Weld Pool
PG Plasma Gas
SG Shield Gas

### FIG. 1

54 Input Unit
55 Output Unit
50 Welding Controller
52 Storage Unit (Database)
51 Central Control Unit
56 Welding Voltage Frequency Analyzing Unit
53 Output Voltage Measuring Unit
20 Drive Unit
30 Welding Power Source
40 Welding Gas Supply Unit

### FIG. 2

Bore Diameter of Welding Torch Chip
10 Welding Torch
Welding Direction
Plasma Gas PG
Shield Gas SG
14 Welding Workpiece
15 Base Metal
16 Plasma Arc
Welding Target Area
Penetration Bead
Weld Pool P
oscillation
Keyhole
Standoff

### FIG. 3

Welding Direction

### FIG. 4

Current Value
Time

### FIG. 5

### FIG. 6

Start
S100 Obtain Welding Condition
S200 Obtain Natural Frequency
S300 Measure Output Voltage
S400 Analyze Welding Voltage Frequency
S500 Determine Welding Quality
S600 Store Data
S700 Welding Finished?
End

### FIG. 7

Start of Determination
S501 Welding Voltage Change Per Unit Time No Greater Than Predetermined Value?
S503 Welding Voltage In Predetermined Range From Reference Voltage?
S505 Identify Peak Frequency
S507 Peak Frequency In Frequency Range?
S509 No Additional Peak Frequency Equal To Or Greater Than Predetermined Level Outside Frequency Range?
S511 Welding Is Determined Good
S513 Welding Is Determined Bad
End of Determination

### FIG. 8

Voltage
Measured Value
Inclination
Discrepancy
Reference Voltage
Time

### FIG. 9A

Power Spectrum
Peak Frequency
Frequency Range
Natural Frequency of Weld Pool
Frequency

### FIG. 9B

Power Spectrum
Peak Frequency
Frequency

### FIG. 9C

Power Spectrum
Peak Generated by Disturbance
Frequency

### FIG. 10

14: Welding Workpiece
15: Base Metal
Penetration Bead

### FIG. 11

Start of Determination
S505 Identify Peak Frequency
S507 Peak Frequency In Frequency Range?
S509 No Additional Peak Frequency Equal To Or Greater Than Predetermined Level Outside Frequency Range?
S501 Welding Voltage Change Per Unit Time No Greater Than Predetermined Value?
S503 Welding Voltage In Predetermined Range From Reference Voltage?
S511 Welding Is Determined Good
S513 Welding Is Determined Bad
End of Determination

### FIG. 12

Start of Determination
S501 Welding Voltage Change Per Unit Time No Greater Than Predetermined Value?
S503 Welding Voltage In Predetermined Range From Reference Voltage?
S505 Identify Peak Frequency
S515 Is Preset Pulse Frequency the Only Identified Peak Frequency?
S511 Welding Is Determined Good
S513 Welding Is Determined Bad
End of Determination

### FIG. 13A

Power Spectrum
Preset Pulse Frequency
Frequency

### FIG. 13B

Power Spectrum
Peak Generated by Disturbance
Preset Pulse Frequency
Frequency

### FIG. 14

Start of Determination
S505 Identify Peak Frequency
S515 Is Preset Pulse Frequency the Only Identified Peak Frequency?
S501 Welding Voltage Change Per Unit Time No Greater Than Predetermined Value?
S503 Welding Voltage In Predetermined Range From Reference Voltage?
S511 Welding Is Determined Good
S513 Welding Is Determined Bad
End of Determination

1. A method of monitoring welding that continuously welds a welding target area of a welding workpiece when forming a keyhole in the welding target area of the welding workpiece by a plasma arc, the method comprising:
an output voltage measuring step that measures an output voltage when a constant current is used for the welding;
a welding voltage frequency analyzing step that analyzes frequencies of those welding voltages, among the output voltages measured by the output voltage measuring step, which possibly correlate to a vibration of a weld pool formed on a back face of a base metal during the welding, to obtain peak frequencies of the welding voltages and their distributions;
a peak frequency identifying step that identifies those peak frequencies which possibly correlate to the vibration of the weld pool, based on frequency analysis results of the welding voltage frequency analyzing step; and
a determination step that compares the peak frequencies identified by the peak frequency identifying step with a preset frequency range to determine a quality of the welding.

2. The monitoring method for plasma arc welding according to claim 1, wherein the determination step determines that the quality of the welding is good if the peak frequencies identified by the peak frequency identifying step fall in the preset frequency range, and determines that the quality of the welding is bad if the peak frequencies identified by the peak frequency identifying step do not fall in the preset frequency range.

3. The monitoring method for plasma arc welding according to claim 2, wherein the determination step determines that the quality of the welding is bad if there is an additional peak frequency equal to or greater than a predetermined level, in addition to a peak frequency in the frequency range.

4. A method of monitoring welding that continuously welds a welding target area of a welding workpiece when forming a keyhole in the welding target area of the welding workpiece by a plasma arc, the method comprising:
an output voltage measuring step of measuring output voltages when a pulse current is used for the welding;
a welding voltage frequency analyzing step of analyzing frequencies of those welding voltages, among the output voltages measured by the output voltage measuring step, which possibly correlate to a vibration of a weld pool formed on a back face of a base metal in the welding target area, to obtain peak frequencies of the welding voltages and their distributions;
a peak frequency identifying step of identifying those peak frequencies which possibly correlate to the vibration of the weld pool, based on frequency analysis results of the welding voltage frequency analyzing step; and
a determination step of comparing the peak frequencies identified by the peak frequency identifying step with a pulse frequency of the pulse current to determine a quality of the welding.

5. The monitoring method for plasma arc welding according to claim 1, wherein when the determination step determines that the welding quality is good under the above-mentioned criteria, the determination step further determines the quality of the welding based on variations in the welding voltage per unit time and discrepancy from a reference voltage.

6. A plasma arc welding device for continuously welding a welding target area of a welding workpiece while forming a keyhole in the welding target area of the welding workpiece with a welding torch, the welding torch being adapted to generate a plasma arc, the device comprising:
an output voltage measuring unit configured to measure an output voltage when a constant current is used for the welding;
a welding voltage frequency analyzing unit configured to analyze frequencies of those welding voltages, among the output voltages measured by the output voltage measuring unit, which possibly correlate to a vibration of a weld pool formed on a back face of a base metal during the welding, to obtain peak frequencies of the welding voltages and their distributions;
a peak frequency identifying unit configured to identify those peak frequencies which possibly correlate to the vibration of the weld pool, based on frequency analysis results of the welding voltage frequency analyzing unit; and
a determination unit configured to compare the peak frequencies identified by the peak frequency identifying unit with a preset frequency range to determine a quality of the welding.

7. A plasma arc welding device for continuously welding a welding target area of a welding workpiece while forming a keyhole in the welding target area of the welding workpiece with a welding torch, the welding torch being adapted to generate a plasma arc, the device comprising:
an output voltage measuring unit configured to measure an output voltage when a pulse current is used for the welding;
a welding voltage frequency analyzing unit configured to analyze frequencies of those welding voltages, among the output voltages measured by the output voltage measuring unit, which possibly correlate to a vibration of a weld pool formed on a back face of a base metal during the welding, to obtain peak frequencies of the welding voltages and their distributions;
a peak frequency identifying unit configured to identify those peak frequencies which possibly correlate to the vibration of the weld pool, based on frequency analysis results of the welding voltage frequency analyzing unit; and
a determination unit configured to compare the peak frequencies of the welding voltages identified by the peak frequency identifying unit with a pulse frequency of the pulse current to determine a quality of the welding.
